(19) United States
(12) Patent Application Publication
(10) Pub. No.: US 2025/0370581 A1
(43) Pub. Date: Dec. 4, 2025

(54) NOTIFICATION MESSAGE DISPLAY METHOD AND APPARATUS, ELECTRONIC DEVICE, AND STORAGE MEDIUM

(71) Applicant: Beijing Zitiao Network Technology Co., Ltd., Beijing (CN)

(72) Inventor: Zhiwei SU, Beijing (CN)

(21) Appl. No.: 18/875,112

(22) PCT Filed: Sep. 13, 2023
(86) PCT No.: PCT/CN2023/118426

§ 371 Date: Dec. 13, 2024

(30) Foreign Application Priority Data
Sep. 20, 2022 (CN) 202211146302.0

(51) Int. Cl. G06F 3/0481

(52) U.S. Cl. CPC G06F 3/0481

(57) ABSTRACT

A notification message display method and apparatus, an electronic device, and a storage medium. The method includes: displaying, in response to a detected notification trigger event, a notification message corresponding to the notification trigger event in a current display interface of a virtual reality scene, wherein the current display interface is provided with at least one of a close-range panel or a navigation bar (S110); and adjusting a display position of the notification message in the current display interface in response to a change in a display state of at least one of the close-range panel or the navigation bar in the current display interface (S120).

This application claims priority to Chinese Patent Application No. 202211146302.0, filed with the China National Intellectual Property Administration on Sep. 20, 2022, which is incorporated herein by reference in its entirety.

### FIELD

Embodiments of the present disclosure relate to a notification message display technology, and for example, to a notification message display method and apparatus, an electronic device, and a storage medium.

### BACKGROUND

In today's society; virtual reality devices have gradually entered the public view. Virtual reality devices can provide users with more vivid and realistic three-dimensional virtual reality scenes, and are becoming more and more popular.

### SUMMARY

The present disclosure provides a notification message display method and apparatus, an electronic device, and a storage medium.

According to a first aspect, an embodiment of the present disclosure provides a notification message display method. The notification message display method includes:
displaying, in response to a detected notification trigger event, a notification message corresponding to the notification trigger event in a current display interface of a virtual reality scene, wherein the current display interface is provided with at least one of a close-range panel or a navigation bar; and
adjusting a display position of the notification message in the current display interface in response to a change in a display state of at least one of the close-range panel or the navigation bar in the current display interface.

According to a second aspect, an embodiment of the present disclosure further provides a notification message display apparatus. The notification message display apparatus includes:
a notification message display module configured to display, in response to a detected notification trigger event, a notification message corresponding to the notification trigger event in a current display interface of a virtual reality scene, wherein the current display interface is provided with at least one of a close-range panel or a navigation bar; and
a display position adjustment module configured to adjust a display position of the notification message in the current display interface in response to a change in a display state of at least one of the close-range panel or the navigation bar in the current display interface.

According to a third aspect, an embodiment of the present disclosure further provides an electronic device. The electronic device includes:
one or more processors; and
a storage apparatus configured to store one or more programs, wherein
the one or more programs, when executed by the one or more processors, cause the one or more processors to implement the notification message display method according to any one of the embodiments of the present disclosure.

According to a fourth aspect, an embodiment of the present disclosure further provides a storage medium including computer-executable instructions, wherein the computer-executable instructions are used to perform the notification message display method according to any one of the embodiments of the present disclosure when executed by a computer processor.

### BRIEF DESCRIPTION OF THE DRAWINGS

Throughout the drawings, the same or similar reference numerals denote the same or similar elements.

It should be understood that the drawings are schematic and that parts and elements are not necessarily drawn to scale.

FIG. 1 is a schematic flowchart of a notification message display according to an embodiment of the present disclosure:

FIG. 2 is a schematic flowchart of another notification message display according to an embodiment of the present disclosure:

FIG. 3 is a schematic diagram of a display position of a notification message according to an embodiment of the present disclosure;

FIG. 4 is a schematic flowchart of another notification message display according to an embodiment of the present disclosure;

FIG. 5 is a schematic diagram of another display position of a notification message according to an embodiment of the present disclosure:

FIG. 6 is a schematic flowchart of another notification message display according to an embodiment of the present disclosure:

FIG. 7 is a schematic diagram of another display position of a notification message according to an embodiment of the present disclosure:

FIG. 8 is a schematic diagram of another display position of a notification message according to an embodiment of the present disclosure:

FIG. 9 is a schematic diagram of a structure of a notification message display apparatus according to an embodiment of the present disclosure; and

FIG. 10 is a schematic diagram of a structure of an electronic device according to an embodiment of the present disclosure.

### DETAILED DESCRIPTION OF EMBODIMENTS

During use of a virtual reality device, a notification message may be received in many scenarios. However, a notification message is usually displayed at a fixed display position of a display interface. Such a display method is often difficult to adapt to a complex and changeable virtual display scene, and may even block important scene information of the virtual reality scene in some scenarios, prevent the user from operating the virtual reality scene, and affect the user experience.

To address the above situation, an embodiment of the present disclosure provides a notification message display method and apparatus, an electronic device, and a storage medium.

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this regard.

The term “include/comprise” used herein and the variations thereof are an open-ended inclusion, namely. “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that the modifiers should be understood as “one or more”, unless the context clearly indicates otherwise.

Names of messages or information exchanged between a plurality of apparatuses in the implementations of the present disclosure are used for illustrative purposes only, and are not used to limit the scope of these messages or information.

It may be understood that before the embodiments of the present disclosure are used, the user shall be informed of the type, scope of use, and usage scenarios of the personal information involved in the present disclosure and obtain the user's authorization through an appropriate manner in accordance with relevant laws and regulations.

For example, when receiving an active request from the user, prompt information is sent to the user to explicitly prompt the user that an operation that the user requests to perform will need to obtain and use the user's personal information. Therefore, the user can independently choose whether to provide personal information to a software or hardware such as an electronic device, an application, a server, or a storage medium that performs the operation in the embodiment of the present disclosure according to the prompt information.

As an optional but non-limiting implementation, in response to receiving the active request from the user, the manner of sending the prompt information to the user may be, for example, a pop-up window, and the prompt information may be presented in text in the pop-up window. In addition, the pop-up window may further carry a selection control for the user to select “agree” or “disagree” to provide personal information to the electronic device.

It may be understood that the above notification and user authorization obtaining process is only illustrative and does not limit the implementation of the present disclosure. Other manners that meet relevant laws and regulations may also be applied to the implementation of the present disclosure.

It may be understood that the data involved in this embodiment (including but not limited to the data itself, the acquisition or use of the data) shall comply with the requirements of corresponding laws, regulations, and relevant provisions.

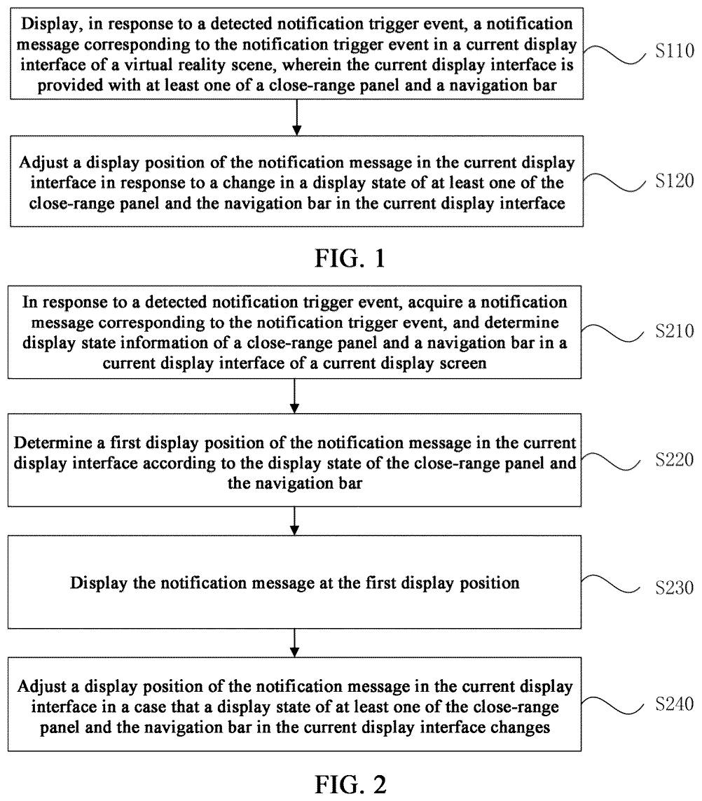

FIG. 1 is a schematic flowchart of a notification message display according to an embodiment of the present disclosure. The embodiment of the present disclosure can flexibly display a notification message in a virtual reality scene. The method may be performed by a notification message display apparatus. The apparatus may be implemented in a form of software and/or hardware, for example, implemented by an electronic device, which may be a mobile terminal, a personal computer (PC) terminal, a server, or the like.

As shown in FIG. 1, the method in the embodiment of the present disclosure may include the following steps.

S110: Display, in response to a detected notification trigger event, a notification message corresponding to the notification trigger event in a current display interface of a virtual reality scene, wherein the current display interface is provided with at least one of a close-range panel or a navigation bar.

The notification trigger event may be understood as an event for triggering display of a notification message in a virtual reality scene. In the embodiment of the present disclosure, the notification trigger event may be determined according to an actual situation, which is not limited herein. For example, it may be that a notification message display request sent by an application is received.

It may be understood that a three-dimensional scene image with depth-of-field information may be displayed in the virtual reality scene. The current display interface may be understood as an image displayed at a current moment in the virtual reality scene.

The notification message may be understood as a message that is associated with the notification trigger event and needs to notify the user. The notification message may include identification information for identifying an application that acquires the notification message. It should be noted that the notification message may be generated by a system control program of a device that displays the virtual reality scene, or may be generated by an application installed in the device. There may be many scenarios in which the notification message is generated, such as detecting that a preset reminder event has occurred, or detecting a message update event, or detecting that an application has a risk of unauthorized use, etc. The generation of the notification message and the type of the generated notification message are not limited herein.

It should be noted that the notification message displayed in the current display interface may be a notification message sent by any application permitted to notify in the virtual reality device. The application may be an application that comes with the virtual reality device, or may be an application selected and installed by the user in the virtual reality device. It may be understood that the virtual reality device provides a control interface for controlling whether a notification message of the application is displayed. The user may set, through the control interface, to allow the application to display the notification message, or may set to prohibit the display of the notification message of the application.

The notification message may include a notification title, notification content, and an icon of the application that acquires the notification message during display. For example, the display of the notification message may also be accompanied by a preset sound effect.

For example, in response to the detected notification trigger event, the notification message is acquired, and then the notification message is sent to the display position of the notification message in the current display interface for display. The close-range panel may be understood as a panel used by the user in the virtual reality scene to display a close-range image of the current display interface. The navigation bar may be understood as a display bar used to display navigation information of the virtual reality scene in the current display interface. The setting of the navigation bar can provide convenience for the user to quickly switch and browse various information in the virtual reality scene.

Exemplarily: the navigation bar may be a display bar for displaying an application list including program identification information of at least one application associated with the virtual reality device. The close-range panel may be a panel for displaying a program interface corresponding to a selected application.

It should be noted that the current display interface may be provided with a close-range panel, a navigation bar, and a far-range panel, which are respectively used to display close-range information, navigation information, and far-range information of the current display interface. It may be understood that the close-range information and the far-range information are relative concepts and are related to a depth of field of the image information. Considering the visual experience of the user, the close-range information and the navigation bar arc information that the user may frequently use and pay more attention to. Therefore, in the embodiment of the present disclosure, it is considered to establish a connection between a display state of the close-range panel and/or the navigation bar and a display position of the notification message.

Before the notification message corresponding to the notification trigger event is displayed in the current display interface of the virtual reality scene in response to the detected notification trigger event, the method may further include: acquiring the notification message according to the notification trigger event. determining an application corresponding to the acquired notification message, and determining display permission of the notification message of the application. In response to detecting that the notification message of the application is permitted to be displayed, the notification message corresponding to the notification trigger event is displayed in the current display interface of the virtual reality scene.

For example, a notification trigger event is detected, and in response to the detected notification trigger event, a notification message is acquired according to the notification trigger event, and an application that generates the notification message is determined according to the acquired notification message. If it is detected that the notification message corresponding to the application is permitted to be displayed, the notification message is sent to the current display interface for display.

S120: Adjust a display position of the notification message in the current display interface in response to a change in a display state of at least one of the close-range panel or the navigation bar in the current display interface.

The display state may be understood as a state for determining whether the close-range panel and the navigation bar in the virtual reality scene are visible to the user. Exemplarily, the display state may be divided into a displayed state and a non-displayed state, or may be divided into a dominant state or a recessive state. It should be noted that the close-range panel and the navigation bar may be understood as information display slots. When there is no close-range information to be displayed, the close-range panel may be set to a non-displayed or hidden state. When there is close-range information to be displayed, the close-range panel may be set to a displayed or dominant state, so that the close-range information will be visible to the user.

In the embodiment of the present disclosure, the change in the display state of the close-range panel and/or the navigation bar in the current display interface may be understood as a case where the close-range panel and/or the navigation bar are switched from a visualized state to an invisible state in the current display interface, or are switched from an invisible state to a visualized state. For example, the switch from the visualized state to the invisible state may be a switch from the displayed state to the non-displayed state, or a switch from the dominant state to the hidden state. The switch from the invisible state to the visualized state may be a switch from the non-displayed state to the displayed state, or a switch from the hidden state to the dominant state.

Exemplarily, the navigation bar may be displayed in the current display interface by default. For example, in response to a received information display trigger operation for navigation information of the navigation bar, if the close-range panel is in an invisible state, the close-range panel is displayed in the current display interface and information corresponding to the information display trigger operation is displayed in the close-range panel. For example, in response to a program trigger operation for an application displayed in the navigation bar, a close-range panel is displayed on the current display interface, and a preset program response interface of the application for the program trigger operation is displayed in the close-range panel.

In an embodiment, in a case that the close-range panel and/or the navigation bar are displayed in the current display interface, in response to a close operation for the close-range panel and/or the navigation bar, the display of the close-range panel and/or the navigation bar is canceled.

For example, in the virtual reality scene, a display state of the close-range panel and/or the navigation bar in the current display interface is detected. When it is detected that the display state of the close-range panel and/or the navigation bar in the current display interface changes, a display position of the close-range panel and/or the navigation bar in the current display interface is determined. A display position of the notification message in the current display interface is determined according to the display position of the close-range panel and/or the navigation bar in the current display interface. The display position of the notification message in the current display interface is adjusted according to the display position of the notification message in the current display interface.

In the embodiment of the present disclosure, in the virtual reality scene, the display position may be a position determined by display height information, display depth information, and display width information in a world coordinate system or a viewpoint coordinate system. It may be understood that in the virtual reality scene, the notification message may also be displayed at different angles or postures.

In an embodiment, the display position of the navigation bar in the current display interface and the display position of the close-range panel in the current display interface may be relatively fixed positions, or may be separate fixed positions. In a case that the display position of the navigation bar and the display position of the close-range panel in the current display interface are relatively fixed, the display position of the close-range panel may be fixedly displayed in an upper area, a lower area, a left area, or a right area of the navigation bar. For example, when the display position of the navigation bar changes, the display position of the close-range panel may change with the display position of the navigation bar. In a case that the display position of the navigation bar and the display position of the close-range panel are separate fixed positions, a change in the display position of the navigation bar does not affect the display position of the close-range panel, and the display position of the close-range panel is still fixed at the original display position.

In the embodiment of the present disclosure, the manner of adjusting the display position of the notification message in the current display interface may be to adjust the display position of the notification message in the current display interface, so that the notification message does not block the close-range panel and/or the navigation bar displayed in the current display interface. It may be understood that in a case that the close-range panel and/or the navigation bar are in an invisible state, it is not necessary to consider the blocking of the close-range panel or the navigation bar that is invisible by the notification message.

In an embodiment, a correspondence between the display state of the close-range panel and the navigation bar and the display position of the notification message is preset according to preset display positions of the close-range panel and the navigation bar in each display interface of the virtual reality scene and various display states of the close-range panel and the navigation bar in the display interface. Then, a target display position of the notification message is determined according to a current display position of the close-range panel and the navigation bar in the current display interface, a current display state of the close-range panel and the navigation bar in the current display interface, and the correspondence. Furthermore, the notification message is adjusted to the target display position in the current display interface.

In the embodiment of the present disclosure, the notification message corresponding to the notification trigger event is displayed in the current display interface of the virtual reality scene in response to the detected notification trigger event, wherein the current display interface is provided with the close-range panel and/or the navigation bar; and the display position of the notification message in the current display interface is adjusted in a case that the display state of the close-range panel and/or the navigation bar in the current display interface changes. The display position of the notification message can be dynamically adjusted, so that the display position of the notification message changes with the change in the display state of the close-range panel and/or the navigation bar, thereby linking the display state of the close-range panel and/or the navigation bar and the display position of the notification message in the current display interface, avoiding the situation in the related art that the notification message is displayed at a fixed position, which results in a mismatch between the display position of the notification message and the virtual reality scene or even blocking of important information. achieving flexible adjustment of the notification message in the virtual reality scene, enriching the display manner of the notification message, improving the adaptation between the display position of the notification message and the display information of the virtual reality scene, and improving the user experience.

FIG. 2 is a schematic flowchart of another notification message display according to an embodiment of the present disclosure. The embodiment of the present disclosure further describes a method of displaying the notification message corresponding to the notification trigger event in the current display interface. As shown in FIG. 2, the method in this embodiment includes the following steps.

S210: In response to a detected notification trigger event, acquire a notification message corresponding to the notification trigger event, and determine display state information of a close-range panel and a navigation bar in a current display interface of a virtual reality scene.

For example, after the notification trigger event is detected, in response to the detected notification trigger event, the notification message corresponding to the notification trigger event is acquired according to the notification trigger event, and the display state of the close-range panel and the navigation bar in the current display interface of the virtual reality scene is acquired. As described above, in the embodiment of the present disclosure, after the notification trigger event is detected, an application corresponding to the notification trigger event may be determined according to the notification trigger event, display permission of the notification message of the application is acquired, and the notification message corresponding to the notification trigger event is acquired in response to detecting that the display of the notification message of the application is permitted.

S220: Determine a first display position of the notification message in the current display interface according to the display state of the close-range panel and the navigation bar.

The first display position may be understood as a position in the current display interface for displaying the notification message. Exemplarily, the first display position may be a display position of the notification message in the current display interface that does not overlap with the display positions of the close-range panel and the navigation bar.

It may be understood that the first display position of the notification message is determined according to the display state of the close-range panel and the navigation bar, and is not a fixed display position. The first display position may also change with the change in the display state of the close-range panel and the navigation bar.

For example, after the display state of the close-range panel and the navigation bar is acquired, the first display position of the notification message in the current display interface is determined according to the display state of the close-range panel and the navigation bar.

As an optional embodiment in the embodiment of the present disclosure, determining the first display position of the notification message in the current display interface according to the display state of the close-range panel and the navigation bar includes: in a case that the close-range panel is displayed in the current display interface, determining a first preset position as the first display position of the notification message, wherein the first preset position is adjacent to the close-range panel and does not overlap with a display position of the close-range panel.

In the embodiment of the present disclosure, in a case that the close-range panel is displayed in the current display interface, the display position of the notification message needs to be prevented from overlapping with the display position of the close-range panel, and the notification message is displayed in such a manner that the user can notice, and then the first preset position of the notification message is set at a position adjacent to the close-range panel and not overlapping with the display position of the close-range panel. It should be noted that in the virtual reality scene, a default display position of the close-range panel is usually set at a middle position in the current display interface, which is often a middle position of the screen. Certainly, the close-range panel may also be set at a display position extending from a display boundary close to a side of the current display interface to a center of the current display panel. A function of adjusting the display position of the close-range panel may also be provided, so that the user can freely adjust the display position of the close-range panel to meet personalized needs of the user.

For example, in a case that it is determined that the close-range panel is displayed in the current display interface, a display position of the close-range panel in the current display interface is acquired, a display position adjacent to the close-range panel and not overlapping with the display position of the close-range panel is determined as the first preset position of the notification message, and then the first preset position is used as the first display position of the notification message.

As an optional embodiment in the embodiment of the present disclosure, the first preset position includes at least a position above the close-range panel and spaced apart from the close-range panel by a first preset distance.

The first preset distance may be understood as a distance between the first preset position and the close-range panel. In the embodiment of the present disclosure, a value of the first preset distance may be set according to an actual requirement, and is not set herein.

In the embodiment of the present disclosure, in a case that it is determined that the close-range panel is displayed in the current display interface, the display position of the close-range panel in the current display interface is acquired, and a position above the close-range panel and spaced apart from the close-range panel by the first preset distance is determined as the first preset position of the notification message.

In the embodiment of the present disclosure, one or more preset display positions may be preset for displaying the notification message in a case that it is determined that the close-range panel is displayed in the current display interface. For example, after the display position of the close-range panel in the current display interface is determined, all preset display positions adjacent to the close-range panel and spaced apart from the close-range panel by the first preset distance are determined according to the display position of the current close-range panel, and then it is determined whether each preset display position is visible in the current display interface. If the preset display position is visible in the current display interface, the preset display position is used as the first preset display position.

It may be understood that the case that the close-range panel is displayed in the current display interface includes a case that only the close-range panel is displayed in the current display interface, and a case that in addition to the close-range panel, a far-range panel and/or the navigation bar are also displayed in the current display interface.

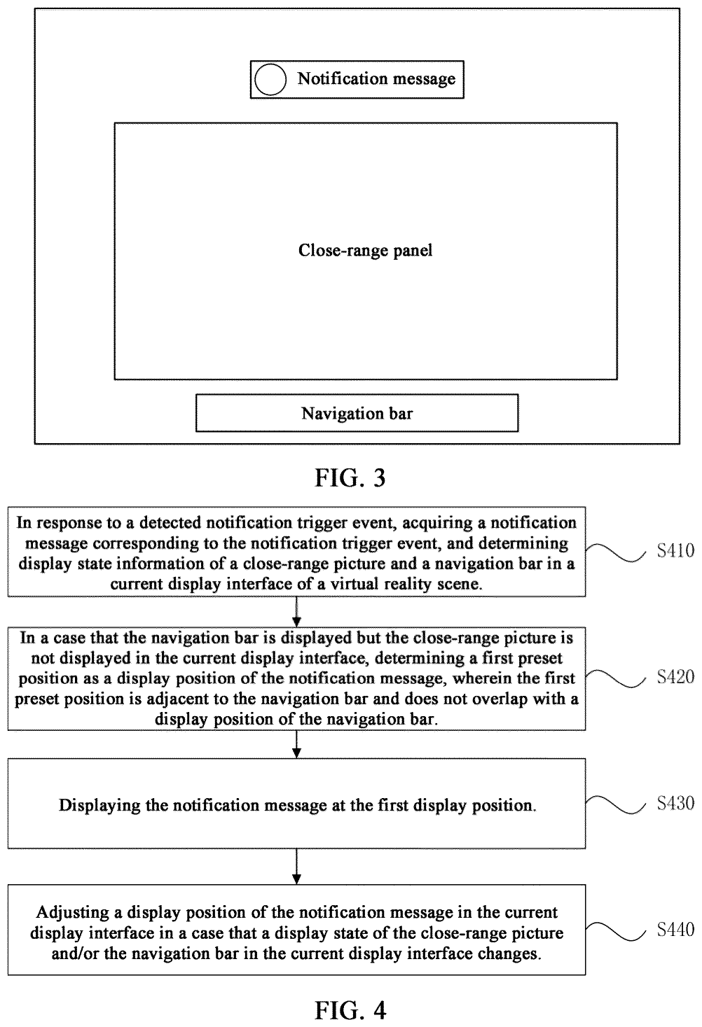

Exemplarily. FIG. 3 is a schematic diagram of a display position of a notification message according to an embodiment of the present disclosure. As shown in FIG. 3, when the close-range panel and the navigation bar are present in the current display interface of the virtual reality scene, the navigation bar is located below the close-range panel in the current display interface, and the close-range panel is displayed at a center position of the current display interface. In this case, the first preset position may be a position above the close-range panel and spaced apart from the close-range panel by the first preset distance, that is, the first display position of the notification message. The advantage of such setting is that the notification message can be prevented from blocking the close-range panel and the navigation bar in the current display interface. S230: Display the notification message at the first display position.

For example, after the first display position of the notification message is determined, the notification message is displayed at the first display position in the current display interface. For example, when a display length of the notification message exceeds a maximum length permitted at the first display position, thumbnail information of the notification message is displayed.

S240: Adjust the display position of the notification message in the current display interface in a case that the display state of the close-range panel and/or the navigation bar in the current display interface changes.

When the notification message needs to be displayed, in order to prevent the notification message from affecting a function that the user is using, it is considered that the display state of the close-range panel and the navigation bar in the current display page, and then the first display position of the notification message is adjusted according to the display state of the close-range panel and the navigation bar in the current display page. The first display position of the notification message can be flexibly adjusted according to a change in the display state of the close-range panel and the navigation bar in the current display page.

In the embodiment of the present disclosure, the display state of the navigation bar and the close-range panel in the current display interface is determined in response to the detected notification trigger event, the first display position of the notification message in the current display interface is determined according to the display state of the close-range panel and the navigation bar, and the display position of the notification message in the current display interface is adjusted according to the display state of the navigation bar and the close-range panel,
and then the notification message is displayed at the first display position. This implements the corresponding adjustment of the display position of the notification message in the current display interface according to the change in the display state of the close-range panel and/or the navigation bar, and the control of the change in the notification message according to the change in the display state of the close-range panel and/or the navigation bar. The display manner of the notification message is optimized, and the visual experience of the user is improved.

FIG. 4 is a schematic flowchart of another notification message display according to an embodiment of the present disclosure. The embodiment of the present disclosure further describes a display position of the notification message in a case that a navigation bar is present but a close-range panel is not present in the current display interface. As shown in FIG. 4, the method includes the following steps.

S410: In response to a detected notification trigger event, acquire a notification message corresponding to the notification trigger event, and determine display state information of a close-range panel and a navigation bar in a current display interface of a virtual reality scene.

S420: In a case that the navigation bar is displayed in the current display interface and the close-range panel is not displayed in the current display interface, determining a second preset position as the first display position of the notification message, wherein the second preset position is adjacent to the navigation bar and does not overlap with a display position of the navigation bar.

In the embodiment of the present disclosure, in a case that the navigation bar is displayed in the current display interface and the close-range panel is not displayed in the current display interface, the display position of the notification message needs to be prevented from overlapping with the display position of the navigation bar, and the notification message is displayed in such a manner that the user can notice, and then the second preset position of the notification message is set at a position adjacent to the navigation bar and not overlapping with the display position of the navigation bar. Similarly, a function of adjusting the display position of the navigation bar may also be provided, so that the user can adjust the display position of the navigation bar as required.

For example, in a case that the navigation bar is displayed in the current display interface and the close-range panel is not displayed in the current display interface, a display position of the navigation bar in the current display interface is acquired, a display position adjacent to the navigation bar and not overlapping with the display position of the navigation bar is determined as the second preset position of the notification message, and then the second preset position is used as the first display position of the notification message.

Considering that in the virtual reality scene, the default display position of the navigation bar is usually set at a lower position of the current display interface, as an optional embodiment in the embodiment of the present disclosure, the second preset position includes at least a position above the navigation bar and spaced apart from the navigation bar by a second preset distance.

The second preset distance may be understood as a distance between the second preset position and the navigation bar. A value of the second preset distance may be set according to an actual requirement, and is not set herein. It should be noted that in the embodiment of the present disclosure, a value of the second preset distance may be the same as or different from that of the first preset distance. In the embodiment of the present disclosure, in a case that it is determined that the navigation bar is displayed in the current display interface and the close-range panel is not displayed in the current display interface, the display position of the navigation bar in the current display interface is acquired, and a position above the navigation bar and spaced apart from the navigation bar by the second preset distance is determined as the second preset position of the notification message.

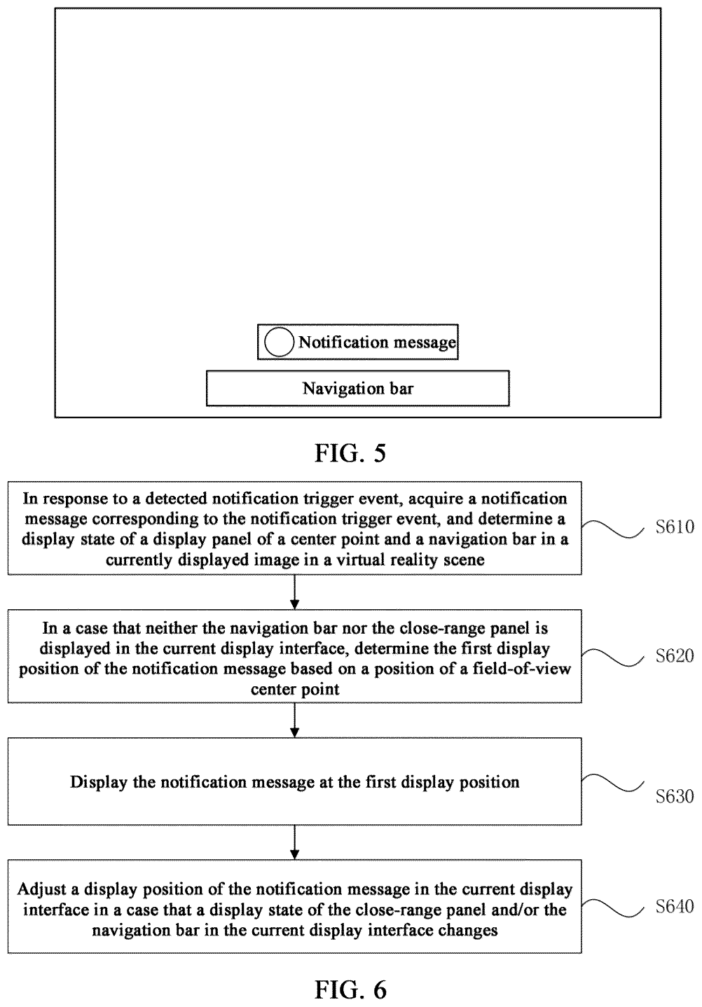

Exemplarily. FIG. 5 is a schematic diagram of another display position of a notification message according to an embodiment of the present disclosure. As shown in FIG. 5, in a case that the close-range panel is not present and the navigation bar is displayed in the current display interface of the virtual reality scene, the navigation bar is located at a lower position in the current display interface, and the close-range panel is not displayed in an upper area of the navigation bar. In this case, the notification message may be displayed at a position above the current display position of the navigation bar and spaced apart from the navigation bar by the second preset distance. This makes it convenient to view the notification message while preventing the notification message from blocking the navigation bar.

For example, the navigation bar is arranged at a display boundary close to a side of the current display interface, and extends in an extension direction of a boundary line of the image. In this case, the second preset position may be a position away from the display boundary and adjacent to the navigation bar, or the second preset position may also be a position at the center of the field of view.

S430: Display the notification message at the first display position.

S440: Adjust the display position of the notification message in the current display interface in a case that the display state of the close-range panel and/or the navigation bar in the current display interface changes.

In the embodiment of the present disclosure, in a case that the navigation bar is displayed in the current display interface and the close-range panel is not displayed in the current display interface, the second preset position adjacent to the navigation bar and not overlapping with the display position of the navigation bar is used as the first display position of the notification message, which can avoid blocking the navigation bar in the current display interface, and facilitate the user to view the notification message in consideration of the association between the notification message and the navigation bar, thereby optimizing the display manner of the notification message and improving the user experience.

FIG. 6 is a schematic flowchart of another notification message display according to an embodiment of the present disclosure. The embodiment of the present disclosure further describes a display position of the notification message in a case that neither a navigation bar nor a close-range panel is present in the current display interface. As shown in FIG. 6, the method includes the following steps.

S610: In response to a detected notification trigger event, acquire a notification message corresponding to the notification trigger event, and determine display state information of a close-range panel and a navigation bar in a current display image of a virtual reality scene.

S620: In a case that neither the navigation bar nor the close-range panel is displayed in the current display interface, determine the first display position of the notification message based on a position of a field-of-view center point.

In the embodiment of the present disclosure, in a case that neither the navigation bar nor the close-range panel is displayed in the current display interface, it means that the virtual reality scene is displayed in the current display interface. In order to display the notification message in such a manner that the user can notice.
and prevent the user from missing the notification message, the first display position of the notification message is determined according to the position of the field-of-view center point of the current display interface of the virtual reality scene. The advantage of doing so is that the user can more conveniently observe the notification message.

In the embodiment of the present disclosure, in a case that neither the navigation bar nor the close-range panel is displayed in the current display interface, the current display interface is acquired, an eye image of the user is acquired by using an image acquisition apparatus, current sight focus information of the user is determined according to the eye image of the user, a virtual image width and a virtual image height of a display interface observed by the eyes of the user in the current display interface are determined according to the sight focus information, a coordinate of the field-of-view center point of the current display interface is determined according to the virtual image width and the virtual image height of the display interface, and then the position of the field-of-view center point of the current display interface is determined. Alternatively, the image acquisition apparatus is used as an eye position, and the position of the field-of-view center point of the current display interface is determined according to the image acquisition apparatus. Alternatively, the position of the center point of the current display interface is used as the field-of-view center point.

For example, in a case that neither the navigation bar nor the close-range panel is displayed in the current display interface, the position of the field-of-view center point in the current display interface is acquired. and the first display position of the notification message is determined according to the position of the field-of-view center point in the current display interface.

As an optional embodiment in the embodiment of the present disclosure, the first display position may be the position of the field-of-view center point.

As another optional embodiment in the embodiment of the present disclosure, the first display position is a position below the field-of-view center point and spaced apart from the field-of-view center point by a third preset distance.

The third preset distance may be understood as a distance between the first display position and the field-of-view center point. A value of the third preset distance may be set according to an actual requirement, and is not set herein. It should be noted that in the embodiment of the present disclosure, a value of the third preset distance may be the same as or different from those of the first preset distance and the second preset distance.

In the embodiment of the present disclosure, in a case that neither the navigation bar nor the close-range panel is displayed in the current display interface, the coordinate of the field-of-view center point in the current display interface is acquired, the position of the field-of-view center point in the current display interface is determined, and then a position below the position of the field-of-view center point in the current display interface and spaced apart from the field-of-view center point by the third preset distance is determined, and this position is determined as the first display position.

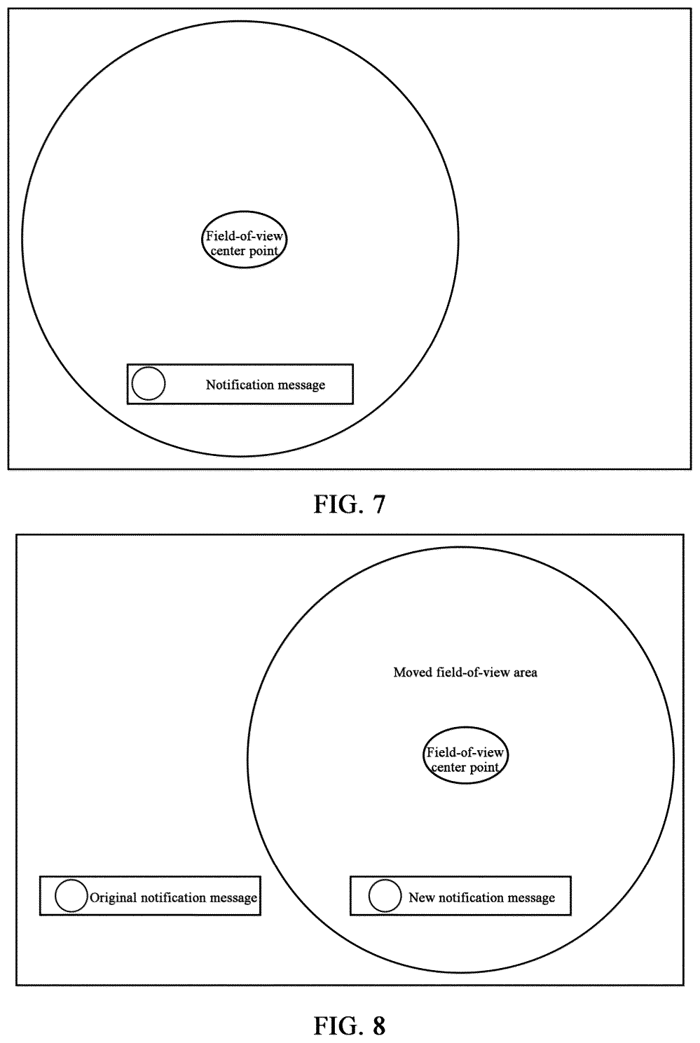

Exemplarily, FIG. 7 is a schematic diagram of another display position of a notification message according to an embodiment of the present disclosure. As shown in FIG. 7, neither the navigation bar nor the close-range panel is displayed in the current display interface. In this case, the notification message may be displayed at a position below the field-of-view center point and spaced apart from the field-of-view center point by the third preset distance.

As an optional embodiment in the embodiment of the present disclosure, the method further includes: in a case that it is detected that the field-of-view center point moves, retaining the notification message for display at the first display position, and causing the notification message disappear after a preset duration of display:

The preset duration may be understood as a preset duration during which the notification message is continuously displayed in the virtual reality scene. A value of the preset duration may be set according to an actual requirement, which is not limited herein. For example, it may be 2 seconds, 3 seconds, or 5 seconds.

In the embodiment of the present disclosure, in order to facilitate the user to promptly view the notification message, the notification message often stays at the display position for a period of time. If the user does not trigger the notification message, the notification message may automatically disappear after staying for a period of time. For example, in response to a view trigger operation for the notification message, jump to an application interface associated with the notification message, or display message details of the notification message in the current display interface.

For example, in a case that it is detected that the field-of-view center point moves in the current display interface, display information of the current display interface also changes accordingly. In this case, the notification message may be retained for display at the first display position, and when it is detected that a duration during which the notification message is continuously displayed reaches the preset duration, the notification message is controlled to disappear, that is, the notification message is no longer displayed.

S630: Display the notification message at the first display position.

S640: Adjust the display position of the notification message in the current display interface in a case that the display state of the close-range panel and/or the navigation bar in the current display interface changes.

In the embodiment of the present disclosure, the first display position of the notification message is determined based on the position of the field-of-view center point in a case that neither the navigation bar nor the close-range panel is displayed in the current display interface, and the notification message is displayed at the first display position. The visual characteristics of the user are fully considered, and the notification message can be displayed at a prominent position of the current display interface, which is convenient for the user to observe and improves the visual experience of the user.

As an optional embodiment in the embodiment of the present disclosure, the method further includes: in a case that it is detected that the field-of-view center point moves, if there is a new notification message, displaying the new notification message at a second display position corresponding to the moved field-of-view center point.

The second display position may be understood as a display position of the notification message that is re-determined based on the moved field-of-view center point after the field-of-view center point moves.

In the embodiment of the present disclosure, in a case that the field-of-view center point moves, in order to ensure the visual experience of the user, the second display position of the notification message may be determined according to the position of the moved field-of-view center point of the current display interface of the virtual reality scene. The advantage of doing so is that it can prevent the situation that the user cannot observe the notification message due to the change in the sight of the user, so that the display position of the notification message changes with the change in the sight.

For example, in a case that it is detected that the field-of-view center point moves, the position of the field-of-view center point after the sight moves in the current display interface is acquired, the second display position of the notification message is determined according to the position of the field-of-view center point in the current display interface, and then if there is a new notification message, the new notification message is displayed at the second display position corresponding to the moved field-of-view center point.

As an optional embodiment in the embodiment of the present disclosure, the method further includes: in a case that the new notification message is displayed at the second display position, controlling the notification message displayed at the first display position to disappear.

In the embodiment of the present disclosure, when the notification message is displayed, the currently latest notification message is usually displayed at the display position of the notification message. During the display of the notification message, in a case that there is a new notification message to be displayed, if the field-of-view center point does not move, the currently displayed notification message may be replaced with the new notification message for display at the first display position, or the new notification message may be added for display at the first display position. In a case that it is detected that the field-of-view center point moves, when the new notification message is displayed at the second display position, the notification message displayed at the first display position may be controlled to disappear.

For example, in a case that it is detected that the field-of-view center point moves, the second display position of the notification message is determined, if there is a new notification message, the new notification message is displayed at the second display position corresponding to the moved field-of-view center point, and the notification message displayed at the first display position is controlled to disappear.

FIG. 8 is a schematic diagram of another display position of a notification message according to an embodiment of the present disclosure. As shown in FIG. 8, in a case that neither the navigation bar nor the close-range panel is displayed in the current display interface, when the field-of-view center point does not move, the first display position is determined according to the field-of-view center point, and the notification message is displayed at the first display position. In a case that the field-of-view center point moves and the notification message is displayed at the first display position, if a new notification message is received, a position below the moved field-of-view center point and spaced apart from the field-of-view center point by the third preset distance is determined as a second display position of the notification message. The new notification message is displayed at the second display position, and the notification message displayed at the first display position is controlled to disappear.

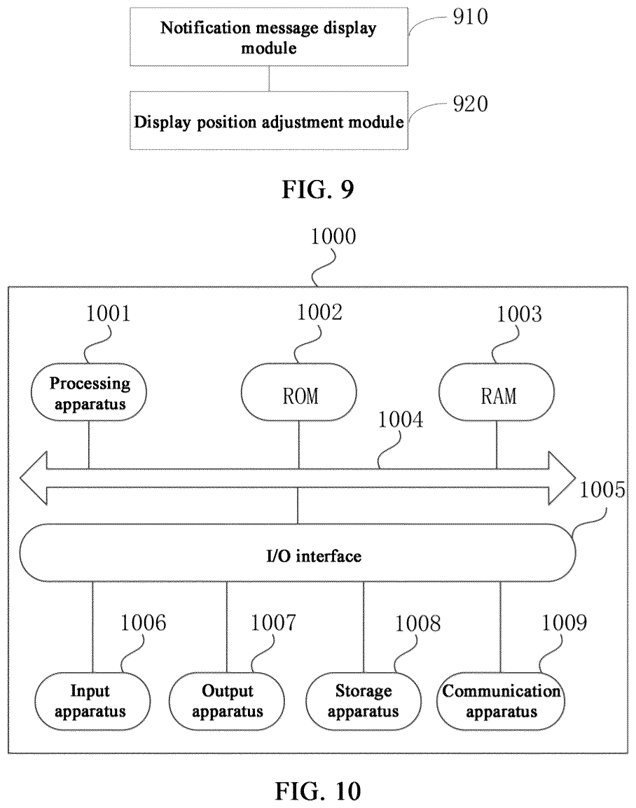

FIG. 9 is a schematic diagram of a structure of a notification message display apparatus according to an embodiment of the present disclosure. As shown in FIG. 9, the notification message display apparatus includes: a notification message display module 910 and a display position adjustment module 920.

The notification message display module 910 is configured to display: in response to a detected notification trigger event, a notification message corresponding to the notification trigger event in a current display interface of a virtual reality scene, wherein the current display interface is provided with a close-range panel and/or a navigation bar; and the display position adjustment module 920 is configured to adjust a display position of the notification message in the current display interface in a case that a display state of the close-range panel and/or the navigation bar in the current display interface changes.

In the embodiment of the present disclosure, the notification message corresponding to the notification trigger event is displayed in the current display interface of the virtual reality scene in response to the detected notification trigger event, wherein the current display interface is provided with the close-range panel and/or the navigation bar; and the display position of the notification message in the current display interface is adjusted in a case that the display state of the close-range panel and/or the navigation bar in the current display interface changes. The display position of the notification message can be dynamically adjusted, so that the display position of the notification message changes with the change in the display state of the close-range panel and/or the navigation bar, thereby linking the display state of the close-range panel and/or the navigation bar and the display position of the notification message in the current display interface, avoiding the situation in the related art that the notification message is displayed at a fixed position, resulting in a mismatch between the display position of the notification message and the virtual reality scene or even blocking of important information. achieving flexible adjustment of the notification message in the virtual reality scene, enriching the display manner of the notification message, improving the adaptation between the display position of the notification message and the display information of the virtual reality scene, and improving the user experience.

In an embodiment, the notification message display module includes:
a message acquisition unit configured to acquire a notification message corresponding to the notification trigger event, and determine display state information of a close-range panel and a navigation bar in a current display interface of a virtual reality scene:
a display position determination unit configured to determine a first display position of the notification message in the current display interface according to the display state of the close-range panel and the navigation bar; and
a message display unit configured to display the notification message at the first display position.

In an embodiment, the display position determination unit is configured to:
in a case that the close-range panel is displayed in the current display interface, use a first preset position as the first display position of the notification message, wherein the first preset position is adjacent to the close-range panel and does not overlap with a display position of the close-range panel.

In an embodiment, the first preset position includes at least a position above the close-range panel and spaced apart from the close-range panel by a first preset distance.

In an embodiment, the display position determination unit is configured to:
in a case that the navigation bar is displayed in the current display interface and the close-range panel is not displayed in the current display interface, use a second preset position as the first display position of the notification message, wherein the second preset position is adjacent to the navigation bar and does not overlap with a display position of the navigation bar.

In an embodiment, the second preset position includes at least a position above the navigation bar and spaced apart from the navigation bar by a second preset distance.

In an embodiment, the display position determination unit is configured to:
in a case that neither the navigation bar nor the close-range panel is displayed in the current display interface, determine the first display position of the notification message based on a position of a field-of-view center point.

In an embodiment, the first display position is a position below the field-of-view center point and spaced apart from the field-of-view center point by a third preset distance.

In an embodiment, the notification message display module further includes:
a notification message retaining module configured to, in a case that it is detected that the field-of-view center point moves, retain the notification message for display at the first display position, and disappear after a preset duration of display:

In an embodiment, the notification message display apparatus further includes:
a notification message updating module configured to, in a case that it is detected that the field-of-view center point moves, if there is a new notification message, display the new notification message at a second display position corresponding to the moved field-of-view center point.

In an embodiment, the notification message display apparatus further includes:
a notification message disappearing module configured to, in a case that the new notification message is displayed at the second display position, control the notification message displayed at the first display position to disappear.

The notification message display apparatus provided in the embodiment of the present disclosure may perform the notification message display method provided in any embodiment of the present disclosure, and has corresponding functional modules and beneficial effects for performing the method.

It should be noted that the various units and modules included in the above apparatus are divided only according to functional logic, but are not limited to the above division, as long as the corresponding functions can be implemented. In addition, the names of the functional units are only for the convenience of mutual distinction, and are not used to limit the scope of protection of the embodiments of the present disclosure.

FIG. 10 is a schematic diagram of a structure of an electronic device according to an embodiment of the present disclosure. Referring to FIG. 10 below; which shows a schematic diagram of a structure of an electronic device (such as a terminal device or a server in FIG. 10) 1000 suitable for implementing the embodiments of the present disclosure. The terminal device in the embodiments of the present disclosure may include, but is not limited to, mobile terminals such as mobile phones, notebook computers, digital broadcast receivers, personal digital assistants (PDAs), tablet computers (PADs), portable multimedia players (PMPs), vehicle-mounted terminals (such as vehicle navigation terminals), and the like, and fixed terminals such as digital televisions (TVs), desktop computers, and the like. The electronic device shown in FIG. 10 is merely an example, and should not impose any limitation on the function and scope of use of the embodiments of the present disclosure.

As shown in FIG. 10, the electronic device 1000 may include a processing apparatus (such as a central processing unit, a graphics processing unit, etc.) 1001, which may perform a variety of appropriate actions and processing according to a program stored in a read-only memory (ROM) 1002 or a program loaded from a storage apparatus 1008 into a random-access memory (RAM) 1003. The RAM 1003 further stores various programs and data required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, and a gyroscope: an output apparatus 1007 including, for example, a liquid crystal display (LCD), a speaker, and a vibrator: the storage apparatus 1008 including, for example, a tape and a hard disk; and a communication apparatus 1009. The communication apparatus 1009 may allow the electronic device 1000 to perform wireless or wired communication with other devices to exchange data. Although FIG. 10 shows the electronic device 1000 with various apparatuses, it should be understood that it is not required to implement or have all the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, wherein the computer program includes program code for performing the method shown in the flowchart. In such an embodiment, the computer program may be downloaded from a network through the communication apparatus 1009 and installed, installed from the storage apparatus 1008, or installed from the ROM 1002. When the computer program is executed by the processing apparatus 1001, the above-mentioned functions defined in the method of the embodiment of the present disclosure are performed.

The names of messages or information exchanged between a plurality of apparatuses in the implementation of the present disclosure are used for illustrative purposes only, and are not used to limit the scope of these messages or information.

The electronic device provided in the embodiment of the present disclosure and the notification message display method provided in the above embodiment belong to the same inventive concept. The technical details not described in detail in this embodiment may be found in the above embodiment, and this embodiment and the above embodiment have the same beneficial effects.

An embodiment of the present disclosure provides a computer storage medium having a computer program stored thereon, when the program is executed by a processor, the notification message display method provided in the above embodiment is implemented.

It should be noted that the above computer-readable medium described in the present disclosure may be a computer-readable signal medium, a computer-readable storage medium, or any combination thereof. The computer-readable storage medium may be, for example but not limited to. electric. magnetic, optical. electromagnetic, infrared, or semiconductor systems, apparatuses, or devices, or any combination thereof. Examples of the computer-readable storage medium may include, but are not limited to: an electrical connection having one or more wires, a portable computer magnetic disk, a hard disk, a random-access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future developed network protocol, such as a hypertext transfer protocol (HTTP), and can be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future developed network.

The above computer-readable medium may be contained in the above electronic device. Alternatively. the computer-readable medium may exist independently, without being assembled into the electronic device.

The above computer-readable medium carries one or more programs that, when executed by the electronic device, cause the electronic device to:
display, in response to a detected notification trigger event, a notification message corresponding to the notification trigger event in a current display interface of a virtual reality scene, wherein the current display interface is provided with a close-range panel and/or a navigation bar; and
adjust a display position of the notification message in the current display interface in a case that a display state of the close-range panel and/or the navigation bar in the current display interface changes.

The storage medium may be a non-transitory storage medium.

The computer program code for performing the operations of the present disclosure may be written in one or more programming languages or a combination thereof, wherein the programming languages include, but are not limited to, an object-oriented programming language, such as Java. Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to a computer of a user through any kind of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, and may also be implemented by means of hardware. The name of a unit does not constitute a limitation on the unit itself in some cases, for example, a first acquisition unit may also be described as “a unit for acquiring at least two Internet protocol addresses”.

The functions described herein above in the context of the present disclosure may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. Examples of the machine-readable storage medium may include electrical connections based on one or more wires, a portable computer disk, a hard disk, a random-access memory (RAM), a read-only memory (ROM), an erasable programmable read-only memory (EPROM) or flash memory, an optic fiber, a portable compact disk read-only memory (CD-ROM), an optical storage device, a magnetic storage device, or any suitable combination thereof.

According to one or more embodiments of the present disclosure, [Example 1] provides a notification message display method, comprising:
displaying, in response to a detected notification trigger event, a notification message corresponding to the notification trigger event in a current display interface of a virtual reality scene, wherein the current display interface is provided with a close-range panel and/or a navigation bar; and
adjusting a display position of the notification message in the current display interface in a case that a display state of the close-range panel and/or the navigation bar in the current display interface changes.

According to one or more embodiments of the present disclosure, [Example 2] provides a notification message display method, comprising:
displaying the notification message corresponding to the notification trigger event in the current display interface of the virtual reality scene, comprising:
acquiring the notification message corresponding to the notification trigger event, and determining display state information of a close-range panel and a navigation bar in a current display interface of a virtual reality scene:
determining a first display position of the notification message in the current display interface according to the display state of the close-range panel and the navigation bar; and
displaying the notification message at the first display position.

According to one or more embodiments of the present disclosure, [Example 3] provides a notification message display method, comprising:
determining the first display position of the notification message in the current display interface according to the display state of the close-range panel and the navigation bar, comprising:

in a case that the close-range panel is displayed in the current display interface, determining a first preset position as the first display position of the notification message, wherein the first preset position is adjacent to the close-range panel and does not overlap with a display position of the close-range panel.

According to one or more embodiments of the present disclosure, [Example 4] provides a notification message display method, wherein the first preset position comprises at least a position above the close-range panel and spaced apart from the close-range panel by a first preset distance.

According to one or more embodiments of the present disclosure, [Example 5] provides the notification message display method, comprising:
determining the first display position of the notification message in the current display interface according to the display state of the close-range panel and the navigation bar, comprising:

in a case that the navigation bar is displayed in the current display interface and the close-range panel is not displayed in the current display interface, determining a second preset position as the first display position of the notification message, wherein the second preset position is adjacent to the navigation bar and does not overlap with a display position of the navigation bar.

According to one or more embodiments of the present disclosure, [Example 6] provides a notification message display method, wherein the second preset position includes at least a position above the navigation bar and spaced apart from the navigation bar by a second preset distance.

According to one or more embodiments of the present disclosure, [Example 7] provides a notification message display method, comprising:
determining the first display position of the notification message in the current display interface according to the display state of the close-range panel and the navigation bar, comprising:

in a case that neither the navigation bar nor the close-range panel is displayed in the current display interface, determining the first display position of the notification message based on a position of a field-of-view center point.

According to one or more embodiments of the present disclosure, [Example 8] provides a notification message display method, wherein the first display position is a position below the field-of-view center point and spaced apart from the field-of-view center point by a third preset distance.

According to one or more embodiments of the present disclosure, [Example 9] provides a notification message display method, comprising:

in a case that it is detected that the field-of-view center point moves, retaining the notification message for display at the first display position, and causing the notification message disappear after a preset duration of display:

According to one or more embodiments of the present disclosure, [Example 10] provides a notification message display method, comprising:

in a case that it is detected that the field-of-view center point moves, if there is a new notification message, displaying the new notification message at a second display position corresponding to the moved field-of-view center point.

According to one or more embodiments of the present disclosure, [Example 11] provides a notification message display method, comprising:

in a case that the new notification message is displayed at the second display position, controlling the notification message displayed at the first display position to disappear.

According to one or more embodiments of the present disclosure, [Example 12] provides a notification message display apparatus, comprising:
a notification message display module configured to display; in response to a detected notification trigger event, a notification message corresponding to the notification trigger event in a current display interface of a virtual reality scene, wherein the current display interface is provided with a close-range panel and/or a navigation bar; and
a display position adjustment module configured to adjust a display position of the notification message in the current display interface in a case that a display state of the close-range panel and/or the navigation bar in the current display interface changes.

A person skilled in the art should understand that the scope of disclosure involved in the present disclosure is not limited to the embodiments formed by a specific combination of the above technical features, but should also cover other embodiments formed by any combination of the above technical features or their equivalent features without departing from the above disclosure concept. For example, an embodiment formed by replacing the above features with technical features with similar functions disclosed in the present disclosure (but not limited to).

In addition, although various operations are depicted in a specific order, it should be understood as requiring these operations to be performed in the specific order shown or in a sequential order. Under certain circumstances, multitasking and parallel processing may be advantageous. Similarly, although several specific implementation details are included in the above discussions, these details should not be construed as limiting the scope of the present disclosure. Some features described in the context of separate embodiments may also be implemented in combination in a single embodiment. In contrast, various features described in the context of a single embodiment may also be implemented in multiple embodiments separately or in any suitable sub-combination. Although the subject matter has been described in a language specific to structural features and/or methodological logical actions, it should be understood that the subject matter defined in the appended claims is not necessarily limited to the specific features or actions described above. In contrast, the specific features and actions described above are merely exemplary forms of implementing the claims.

1. A notification message display method, comprising:
displaying, in response to a detected notification trigger event, a notification message corresponding to the notification trigger event in a current display interface of a virtual reality scene, wherein the current display interface is provided with at least one of a close-range panel and a navigation bar; and
adjusting a display position of the notification message in the current display interface in response to a change in a display state of at least one of the close-range panel or the navigation bar in the current display interface.

2. The notification message display method of claim 1, wherein displaying the notification message corresponding to the notification trigger event in the current display interface of the virtual reality scene comprises:
acquiring the notification message corresponding to the notification trigger event, and determining the display state of the close-range panel and the navigation bar in the current display interface of the virtual reality scene;
determining a first display position of the notification message in the current display interface according to the display state of the close-range panel and the navigation bar; and
displaying the notification message at the first display position.

3. The notification message display method of claim 2, wherein determining the first display position of the notification message in the current display interface according to the display state of the close-range panel and the navigation bar includes:
in a case that the close-range panel is displayed in the current display interface, determining a first preset position as the first display position of the notification message, wherein the first preset position is adjacent to the close-range panel and does not overlap with a display position of the close-range panel.

4. The notification message display method of claim 3, wherein the first preset position comprises at least a position above the close-range panel and spaced apart from the close-range panel by a first preset distance.

5. The notification message display method of claim 2, wherein determining the first display position of the notification message in the current display interface according to the display state of the close-range panel and the navigation bar comprises:
in a case that the navigation bar is displayed in the current display interface and the close-range panel is not displayed in the current display interface, determining a second preset position as the first display position of the notification message, wherein the second preset position is adjacent to the navigation bar and does not overlap with a display position of the navigation bar.

6. The notification message display method of claim 5, wherein the second preset position comprises at least a position above the navigation bar and spaced apart from the navigation bar by a second preset distance.

7. The notification message display method of claim 2, wherein determining the first display position of the notification message in the current display interface according to the display state of the close-range panel and the navigation bar comprises:
in a case that neither the navigation bar nor the close-range panel is displayed in the current display interface, determining the first display position of the notification message based on a position of a field-of-view center point.

8. The notification message display method of claim 7, wherein the first display position is a position below the field-of-view center point and spaced apart from the field-of-view center point by a third preset distance.

9. The notification message display method of claim 7, further comprising:
in response to detecting that the field-of-view center point moves, retaining the notification message for display at the first display position, and causing the notification message disappear after a preset duration of display.

10. The notification message display method of claim 7, further comprising:
in response to detecting that the field-of-view center point moves, in accordance with a determination that there is a new notification message, displaying the new notification message at a second display position corresponding to the moved field-of-view center point.

11. The notification message display method of claim 10, further comprising:
in response to the new notification message being displayed at the second display position, controlling the notification message displayed at the first display position to disappear.

12. (canceled)

13. An electronic device, comprising:
one or more processors; and
a storage apparatus configured to store one or more programs,
wherein the one or more programs, when executed by the one or more processors, cause the one or more processors to:
display, in response to a detected notification trigger event, a notification message corresponding to the notification trigger event in a current display interface of a virtual reality scene, wherein the current display interface is provided with at least one of a close-range panel and a navigation bar; and
adjust a display position of the notification message in the current display interface in response to a change in a display state of at least one of the close-range panel or the navigation bar in the current display interface.

14. A non-transitory storage medium containing computer-executable instructions, wherein the computer-executable instructions, when executed by a computer processor, cause the computer processor to:
display, in response to a detected notification trigger event, a notification message corresponding to the notification trigger event in a current display interface of a virtual reality scene, wherein the current display interface is provided with at least one of a close-range panel and a navigation bar; and
adjust a display position of the notification message in the current display interface in response to a change in a display state of at least one of the close-range panel or the navigation bar in the current display interface.

15. The electronic device of claim 13, wherein displaying, in response to the detected notification trigger event, the notification message corresponding to the notification trigger event in the current display interface of the virtual reality scene comprises:
acquiring the notification message corresponding to the notification trigger event, and determining the display state of the close-range panel and the navigation bar in the current display interface of the virtual reality scene;
determining a first display position of the notification message in the current display interface according to the display state of the close-range panel and the navigation bar; and
displaying the notification message at the first display position.

16. The electronic device of claim 15, wherein determining the first display position of the notification message in the current display interface according to the display state of the close-range panel and the navigation bar includes:
in a case that the close-range panel is displayed in the current display interface, determining a first preset position as the first display position of the notification message, wherein the first preset position is adjacent to the close-range panel and does not overlap with a display position of the close-range panel.

17. The electronic device of claim 16, wherein the first preset position comprises at least a position above the close-range panel and spaced apart from the close-range panel by a first preset distance.

18. The electronic device of claim 15, wherein determining the first display position of the notification message in the current display interface according to the display state of the close-range panel and the navigation bar comprises:
in a case that the navigation bar is displayed in the current display interface and the close-range panel is not displayed in the current display interface, determining a second preset position as the first display position of the notification message, wherein the second preset position is adjacent to the navigation bar and does not overlap with a display position of the navigation bar.

19. The electronic device of claim 18, wherein the second preset position comprises at least a position above the navigation bar and spaced apart from the navigation bar by a second preset distance.

20. The electronic device of claim 15, wherein determining the first display position of the notification message in the current display interface according to the display state of the close-range panel and the navigation bar comprises:
in a case that neither the navigation bar nor the close-range panel is displayed in the current display interface, determining the first display position of the notification message based on a position of a field-of-view center point.

21. The electronic device of claim 20, wherein the first display position is a position below the field-of-view center point and spaced apart from the field-of-view center point by a third preset distance.
